(19) United States
(12) Patent Application Publication
(10) Pub. No.: US 2024/0068656 A1
(43) Pub. Date: Feb. 29, 2024

(54) HYBRID FURNITURE AND VOLUMETRIC LIGHT DISPLAY SYSTEM DEVICE

(71) Applicant: Alexander Michael Ard-Kelly, Atlanta, GA (US)

(72) Inventor: Alexander Michael Ard-Kelly, Atlanta, GA (US)

(21) Appl. No.: 17/822,122

(22) Filed: Aug. 24, 2022

(51) Int. Cl. F21V 33/00; A47B 9/06; A47B 97/00

(52) U.S. Cl. CPC F21V 33/0012; A47B 9/06; A47B 97/00; A47B 2009/065; A47B 2200/004

(57) ABSTRACT

The present invention comprises a novel device with the combined functionality of (1) a piece of furniture and (2) a volumetric light display system, depending on its mode. The third key component of the invention is an actuation system, allowing the invention to change its functionality between that of a piece of furniture and that of a volumetric light display system, achieved by physically moving the device or a portion of the device through space. Such an actuation system is comprised of any number of controllers and powered actuators or actuation subsystems to enable the device to change between a furniture mode and a volumetric light display system mode.

### CROSS-REFERENCE TO RELATED APPLICATIONS

This application claims the benefit of one earlier-filed provisional application under 35 U.S.C. § 119(e): provisional application No. 63/237,107, filed on 2021 Aug. 25, by first inventor Alexander Michael Ard-Kelly, titled HYBRID FURNITURE AND VOLUMETRIC LIGHT DISPLAY SYSTEM DEVICE.

### BACKGROUND OF THE INVENTION

The present invention relates to the fields of volumetric light display systems and furniture in equal measure.

Furniture (as defined in ¶0023, infra) is among the oldest technology in existence and the variety within the field of furniture encompasses many designs and types of devices.

The field of VLDS (as defined in ¶0024, infra) comprises holograms, refractive projections, reflective displays, and any other method of manipulating light to create the appearance of a three-dimensional image while reducing or eliminating the appearance of the media onto which that image is displayed.

### BRIEF SUMMARY OF THE INVENTION

No existing device currently combines the functionalities of Furniture and a VLDS into one device. The contemplated device functions as either traditional Furniture or as a VLDS, depending on its state or mode. Changing between these states or modes requires some sort of powered actuation system (“Actuation Subsystem”) that moves the device or a portion of the device through space. The innovative and novel characteristics of this invention stem from the incorporation of this Actuation Subsystem into the device to transform the device between a Furniture mode and a VLDS mode.

The present invention comprises three subsystems defined by functionality. These are: (1) a Furniture subsystem consisting of the elements to allow the device to function as a normal piece of furniture, (2) a VLDS subsystem consisting of the elements to allow the device to create volumetric light displays, and (3) an Actuation Subsystem consisting of the elements to transform the device between the Furniture mode and the VLDS mode. Each of the three subsystems may share some elements in common with either or both of the other subsystems.

The present invention has the ability to function as a piece of Furniture and as a VLDS under different circumstances. The ability to switch between these two functionalities via an Actuation Subsystem is both novel and core to the device's functionality.

### BRIEF DESCRIPTION OF THE DRAWINGS

Some embodiments of the present invention are illustrated as an example, and the invention is not limited by the descriptions, figures, or the accompanying drawings, in which like references may indicate similar elements and in which:

FIG. 1 depicts a block diagram of the device as a whole and its functionalities.

FIG. 2 depicts one instance of the device: in this case, a table with the ability to transform into a VLDS and back again into a table via an Actuation Subsystem in the form of linear actuators.

FIG. 3 depicts the actuation process of a potential configuration of this device in further detail.

FIG. 4 depicts the Actuation Subsystem of a potential configuration of this device in further detail.

FIG. 5(a) depicts one potential configuration of the device in VLDS mode.

FIG. 5(b) depicts the same potential configuration of the device in Furniture Mode.

FIG. 6 depicts the placement of the screw jacks within the hollow table legs of the potential configuration of the device depicted in FIGS. 5(a) and 5(b).

FIG. 7 highlights the placement of the electric motors attached to each table leg of the potential configuration of the device depicted in FIGS. 5(a) and 5(b).

FIG. 8(a) depicts a detailed example of an electric motor, as shown in FIG. 7, turning a worm gear that turns a screw jack within a hollow table leg of the potential configuration shown in FIGS. 5(a) and 5(b). FIG. 8(b) depicts a detailed example of an electric motor, as depicted in FIG. 7, in an alternate configuration, this time turning a bevel gear that turns a screw jack within a hollow table leg of the potential configuration of the device shown in FIGS. 5(a) and 5(b).

FIG. 9 depicts a detailed example of the threaded rod of a screw jack, capped with a special nut and washer, within a hollow table leg of the potential configuration of the device shown in FIGS. 5(a) and 5(b), lifting a hidden cylinder.

FIG. 10 depicts a detailed example of the other end of a hidden cylinder, as shown in FIG. 9, attached to the underside of the tabletop of the potential configuration shown in FIGS. 5(a) and 5(b) and supporting said tabletop.

FIG. 11 illustrates how as the hidden cylinders depicted in FIGS. 9 and 10 rise (a), they lift (b) the tabletop, causing the Screens to pivot down (c) into position, on the potential configuration of the device shown in FIGS. 5(a) and 5(b).

FIG. 12 depicts a Projector, illustrated as a black-screened computer monitor, attached to the underside of the tabletop and configured at the precise angle relative to the Screen to create the optimum viewing experience, on the potential configuration shown in FIGS. 5(a) and 5(b).

FIG. 13 demonstrates how the trim of the tabletop creates a “skirt” that hides the Projectors from view on the potential configuration of the device depicted in FIGS. 5(a) and 5(b).

FIG. 14 demonstrates the much simpler version of the device, in Furniture mode.

FIG. 15 demonstrates the same much simpler version of the device depicted in FIG. 14, now in VLDS mode.

### DETAILED DESCRIPTION OF THE INVENTION

“Furniture” in this case means large equipment, such as tables, chairs, and cabinets, used to make a house, office, or other space suitable for living or working. Furniture may be made of any material, including but not limited to wood, plastic, metal, stone, concrete, resin, fiber, fabric, gel, or any composite, conglomerate, or combination thereof. The Furniture functionality comprised by the device can relate to any form of Furniture, though not strictly pertaining to the dictionary definition of furniture, especially so far as a dictionary specifies “furniture” to be movable. For instance, in this case, both a movable and an affixed table are considered Furniture, thus the device could comprise a Furniture mode of either type. For clarity, as used herein, the term Furniture also includes types of furniture other than tables, including but not limited to: desks; conference tables; dining tables; coffee tables; end tables; cabinets; armoires; shelves or shelving units; bookcases; counters; countertops; stands; pedestals; pulpits; podiums; pews; cases; stools; ottomans; carts; chairs; sofas; recliners; couches; thrones; benches; toilets; sinks; basins; tubs; showers; light fixtures; ceiling fans; ceiling fixtures; wall fixtures; floor fixtures; mirrors; paintings or other wall-mounted, floor-mounted, or ceiling-mounted art or decorative works; and any other manner of furniture or fixture, regardless of mobility. As contemplated by this application, any of these Furniture embodiments may be movable or affixed.

“Volumetric Light Display System” (“VLDS”) in this case means any method of light display designed to create the appearance of a three-dimensional image, including holograms and any other refractive displays, through or onto any media, while reducing or eliminating the appearance of the media onto which the image is displayed. The VLDS functionality contemplated by this application can relate to any form of volumetric light display including holograms, refractive displays, and any other method of manipulating light to create the appearance of a three-dimensional image. “Display” encompasses both the projection of an image, and that image's reflection, refraction, or appearance upon a Screen.

The terminology used herein is for the purpose of describing potential configurations of the device only and is not intended to be limiting of the invention. As used herein, the term “and/or” includes any and all combinations of one or more of the associated listed items. As used herein, the singular forms of words and the indefinite and definite articles “a,” “an,” and “the” are intended to include their corresponding plural forms as well as their singular forms, and plural forms of words and articles are intended to include their corresponding singular forms as well as their plural forms, unless the context clearly indicates otherwise. As used herein, the terms “comprises” and/or “comprising” specify the presence of stated features, steps, operations, elements, components, and/or groups thereof, but do not preclude the presence or addition of one or more other features, steps, operations, elements, components, and/or groups thereof. Any references to paragraphs, sections, figures, or appendices used herein are to the corresponding paragraph, section, figure, or appendix of this Application.

Unless otherwise defined, all terms (including technical and scientific terms) used herein have the same meaning as commonly understood by one having ordinary skill in the art to which this invention belongs. Terms such as those defined in commonly used dictionaries should be interpreted as having a meaning that is consistent with their meaning in the context of the relevant art and in the present disclosure and should not be interpreted in an idealized or overly formal sense unless expressly so defined herein. Capitalized terms have the definition provided herein; nothing in this paragraph is intended in any way to limit the definition of any term specifically defined anywhere within this application. In the case of any conflict between a dictionary definition and any defined term within this application, the defined term within this application shall control.

In describing the invention, a number of techniques, steps, parts, and pieces are disclosed. Each of these has individual benefits and each can also be used in conjunction with one or more, or in some cases all, of the other disclosed techniques, steps, parts, or pieces. Accordingly, for the sake of clarity, this description will refrain from repeating every possible combination of the individual techniques, steps, parts, and pieces in an unnecessary and cumulative manner. Nevertheless, the specification and claims should be read with the understanding that such other, different, and varied combinations are entirely within the contemplation and scope of the invention and the claims.

The Furniture functionality comprised by the device can relate to any form of Furniture, though not strictly pertaining to the dictionary definition of furniture, especially so far as “furniture” is specified to be movable in a dictionary.

The VLDS system utilizes video interface devices (“Projector” or “Projectors”), as more fully explored infra, to project or reflect light onto the media upon which the image may be displayed (“Screen” or “Screens”), including specially designed non-refractive translucent surfaces, as more fully explored infra, including but not limited to Transparent Solids (e.g., Plexiglas oriented at a precise angle to create the desired appearance of a three-dimensional image while reducing or eliminating the appearance of the media onto which that image is displayed.).

This design specifically contemplates utilizing different types of Projectors. In different embodiments, this design contemplates using as Projectors: light projectors (e.g., 4010 Projector model number V11H9320 manufactured by Seiko Epson Corporation of Shinjuku, Tokyo, Japan); flat panel monitors (e.g., Dell model number 1907 monitor manufactured by Dell Corporation of Round Rock, TX; or ProArt model number PQ22UC 4K HDR OLED Professional Portable Monitors manufactured by ASUSTek Computer Inc. of Beitou District, Taipei, Taiwan); Cathode Ray Tube monitors or televisions (e.g., Compaq Presario 1510 Color Monitor model number 313A manufactured by Compaq Computer Corporation of Houston, TX); tablet computers (e.g., ASUS Chromebook Tablet model number CT100PA manufactured by ASUSTek Computer Inc. of Beitou District, Taipei, Taiwan; or the Xperia model number Z4 Tablet manufactured by Sony Group Corporation of Tokyo, Japan); smart phones (e.g., SONY Xperia 1 III model number XQ-BC72 manufactured by Sony Group Corporation of Tokyo, Japan; the iPhone 11 manufactured by Apple Inc. of Cupertino, CA; or the ZenFone 8 manufactured by ASUSTek Computer Inc. of Beitou District, Taipei, Taiwan); video projectors (e.g., the Performance model number V630 1080p manufactured by Vankyo of Shenzhen, Guangdong, China); and/or laser projectors (e.g., model number HU85LA Ultra Short Throw 4K UHD Laser manufactured by LG of Seoul, South Korea; or the EpiqVision Mini model number EF12 manufactured by Seiko Epson Corporation of Shinjuku, Tokyo, Japan); among other potential types of projection devices. In this paragraph and throughout this Application, all lists of specific devices are for potential reference only and are in no way intended to be an exclusive list of devices which could function in the specified role in other embodiments of the invention. Utilizing any and all such other devices or models of devices is within the contemplation of this Application.

This design specifically contemplates utilizing different types of Screens. In different embodiments, this design contemplates Screens comprised of: Lexan of any thickness manufactured by any manufacturer; polycarbonate sheets or films of any thickness manufactured by any manufacturer (e.g., Thick Acrylic Clear Sheet Falken Design model number ACRYLIC-CL-1-4/2472 manufactured by Falken Design of Compton CA; or Acrylic Sheet Clear Cast Plexiglass model number EAN 0856592008418 manufactured by SimbaLux of Los Angeles, California); sheer fabrics such as silk, vinyl, chiffon, georgette, or gauze (e.g., 16 Gauge Vinyl 54″ Clear manufactured by Jo-Ann Stores, Inc. of Hudson, OH; or Silk Organza Press Cloth manufactured by Helen Haughey Designs of Celebration, Florida); reflective film (e.g., APET [Amorphous Polyethylene Terephthalate] manufactured by Polymer films of Charlotte, North Carolina; or Hostaphan Polyester Film manufactured by Mitsubishi Chemical of Chiyoda City, Tokyo, Japan), either held fixed in rigid frames or semi-flexible, depending on the needs of that particular embodiment; and/or one-sided mirrors (e.g., One-Way Window Film model number ASIN B07PHBYZ1F manufactured by HIDBEA of Newark, CA; or Mirropane one way mirror manufactured by Pilkington of Toledo, Ohio); among other potential types of media upon which the image may be displayed or reflected. In other embodiments, this design contemplates Screens made of gasses or liquid droplets suspended in the air, such as a “gaseous cloud” constantly regenerated by evaporating dry ice (e.g., Fog Machine, Theefun model number 400W Smoke Machine with 2000CFM manufactured by FogTheefun Store of Furong, Changsha, China; or Chauvet DJ Nimbus—Dry Ice Ground Fogger manufactured by Chauvet DJ of Sunrise, FL), among other potential types of gaseous clouds upon which the image may be displayed or reflected.

This design specifically contemplates utilizing different numbers of Projectors and Screens. Any number of Projectors and Screens are contemplated by this design. The number of Projector(s) may or may not equal the number of Screen(s). The defined terms “Projector,” “Projectors,” “Screens,” and “Screens,” as used herein, specifically contemplate both the singular and the plural definitions of those terms.

This design specifically contemplates embodiments in which the image processing and manipulation occurs onboard the device, remote from the device, or in any combination of both onboard and remote image processing and manipulation. This design specifically contemplates embodiments in which onboard image processing and manipulation occurs in one or more of the microcomputers discussed infra, or in a separate microcomputer or graphics processing unit or units specially devoted to graphics processing and manipulation. In one potential embodiment, the image is supplied to a device known as an HDMI splitter (e.g. MT-ViKI 4-Port HDMI Splitter model number SP104M manufactured by Guangdong MT-ViKI Electronics Technology Co., Ltd. of Dong Guan, Guangdong, China) which processes and manipulates the image by splitting it into four identical images and then supplying each processed image via four unique output cables to four Projectors for projection onto four Screens, enabling the image to be viewed from any direction. This design specifically contemplates all other methods of electronic image processing and manipulation.

The VLDS projects the image onto a Screen that blends into the background by reducing or eliminating the appearance of the media onto which the image is displayed, thereby creating the impression of a three-dimensional image suspended in space. When the Screen blends into the background by reducing or eliminating the appearance of the media onto which the image is displayed and the eye is not drawn to the Screen, the brain interprets the image as floating midair. This design specifically contemplates embodiments in which the Screen blends into its background by reducing or eliminating the appearance of the media onto which the image is displayed by virtue of the inherent non-refractive translucent characteristics of that media, e.g., Plexiglas or Lexan. This design also specifically contemplates embodiments in which the Screen blends into the background by reducing or eliminating the appearance of the media onto which the image is displayed by virtue of a combination of the sheer qualities of the Screen material in ambient lighting settings that minimize the appearance of that Screen, e.g., silk or vinyl fabrics. This design also specifically contemplates embodiments in which the Screen blends into the background by reducing or eliminating the appearance of the media onto which the image is displayed by virtue of the amorphous and very small nature of the constituent reflective particles comprising the Screen material, e.g., a “gaseous cloud” constantly dissipating and regenerating from evaporating dry ice. Furthermore, this design specifically contemplates embodiments in which the Screen blends into the background by reducing or eliminating the appearance of the media onto which the image is displayed, in whole or in part, by virtue of the manipulation of light and shadow cast by any combination of pieces or components of the device, e.g., part of the device creating a shadow or shade over the Screen.

The Actuation Subsystem is comprised of any number of powered actuators of any sort including but not limited to: cranks, levers, pulleys, pistons, chains, cables, rods, fibers, worm screw drives, jack screws, bevel gears, planetary gears, motors, linear actuators, shape metal alloy, electromagnets, hinges, and any other device which moves or deforms with power. Any type of electric motor may be embodied in a specific design as contemplated by this application, including but not limited to: linear motors, synchronous motors, reluctance motors, hysteresis motors, induction motors, single phase motors, multi-phase motors, self-excited motors, series motors, short-shunt compound motors, long-shunt compound motors, and/or separately excited motors. As contemplated by this application, the motors may be: brushless, brushed, stepper, and/or otherwise configured. Other forms of powered movement, including but not limited to: moving the entire device or parts of the device manually, hand cranks, hydraulic pumps, or pneumatic lifts are also contemplated by this application. This Actuation Subsystem is also comprised of a controller or system of controllers that stabilize the actuation to any degree or to no degree using digital, analog, and/or mechanical controls, and that enable and/or disable the actuation. The Actuation Subsystem is also comprised of a signaling element, affixed to the device or remote from the device, including but not limited to: buttons, switches, Piezo generators, sensors of any sort, external communication receivers and signalers such as remote controls, and/or any other signaling elements or combination of signaling elements that enable the device to receive commands to engage the actuation system and to switch between Furniture mode and VLDS mode. This design specifically contemplates any type of signaling element or remote controller, including but not limited to those transmitting and/or receiving signals: by wire, by infrared electromagnetism, by optical light, by laser (e.g., by Li-Fi technology), by sound waves (e.g., by The Clapper, manufactured by Joseph Enterprises of San Francisco, CA), by Wi-Fi, by radio waves, by Bluetooth technology, by cellular telephone technology of any generation, and/or by internet enabled devices (e.g., Amazon Alexa Smarthome Device manufactured by Amazon.com of Seattle, WA; Nest Hub Max manufactured by Alphabet Inc. of Mountain View, CA; Ring Bridge manufactured by Amazon.com of Seattle, WA; or Apple HomePod manufactured by Apple Computer, Inc. of Cupertino, CA, and/or by any similar or competing smart home device or other internet enabled device currently in existence or to be developed in the future). Examples of remote control devices which may be used to signal the Actuation Subsystem and which are anticipated by this application explored infra, include but are not limited to: Bluetooth Controllers (e.g., Xbox Wireless Controller manufactured by Microsoft Corporation of Redmond, WA; or Wii Remote manufactured by Nintendo of America of Redmond, WA), Radio Frequency (RF) Controllers (e.g., Wireless Mouse model number M317 with Unifying Receiver manufactured by Logitech International S.A. of Newark, CA; or DirecTV model number 4336303112 RC73 IR/RF Remote Control manufactured by DirecTV of Denver, Co.), Infrared (IR) Controllers (e.g., One For All Streamer Remote model number URC7935 manufactured by Universal Electronics Inc. of Scottsdale, Arizona; or Valve Index controller manufactured by Valve Technologies of Houston TX), Optical/Camera Sensor Controllers (e.g., Kinect for Xbox One manufactured by Microsoft Corporation of Redmond, WA; or PlayStation Eye manufactured by Sony Group Corporation of Tokyo, Japan; or Oculus Quest 2 Manufactured by Facebook Technologies of Menlo, CA), USB Controllers (e.g., HP Wired USB Keyboard model number HP 803181-001 manufactured by Hewett-Packard of Palo Alto, CA; or Dell Wired Keyboard model number KB216-BK-US manufactured by Dell Corporation of Round Rock, TX), and/or PS/2 Controllers (e.g., HP PS/2 Windows Keyboard model number 672646-003 manufactured by Hewett-Packard of Palo Alto, CA; or Logitech PS/2 Classic Keyboard model number K100 manufactured by Logitech International S.A. of Newark, CA). This application also contemplates embodiments of the device incorporating a custom-built remote controller. This design specifically contemplates using any manner of lifting technology to control the orientation of the tabletop and/or Screens, including but not limited to: frames, cables, ropes, wires, strings, twines, yarns, cords, pulleys, hoists, hinges, chains, pushrods, levers, pistons, hydraulics, gears, cogs, hinges, and/or tracks. This design specifically contemplates any method of lifting the tabletop and/or Screens, such as: (1) simple Actuation Subsystems (e.g., lifting or moving the entire device, the tabletop, and/or the Screens or other parts by hand); (2) intermediately complex Actuation Subsystems (e.g., using a hand crank or manually powered lever to lift and stabilize the tabletop and/or Screens); and/or (3) complexly powered Actuation Subsystems (e.g., using electric motors or hydraulic pumps to lift and stabilize the tabletop and/or Screens). This design specifically contemplates any method of stabilizing the tabletop and/or Screens, such as: (1) simple stabilization techniques (e.g., manually securing them in place with fasteners such as tape or similar adhesives, pegs, clips, wire ties, zip ties, snaps, buttons, elastic, and/or hook-and-loop fasteners); (2) intermediately complex Actuation Subsystems (e.g., securing them using the friction of a crank or motor on a guide wire, the friction of a manually secured lever, and/or the static pressure within a hydraulic line); and/or (3) complex Actuation Subsystems (e.g., securing them by pins or locks that are automatically or manually engaged via devices including but not limited to powered actuators). This design also contemplates an actuation system as simple as a human being manipulating the entire device by hand, e.g., by flipping it upside down, as described more fully in ¶0046, infra.

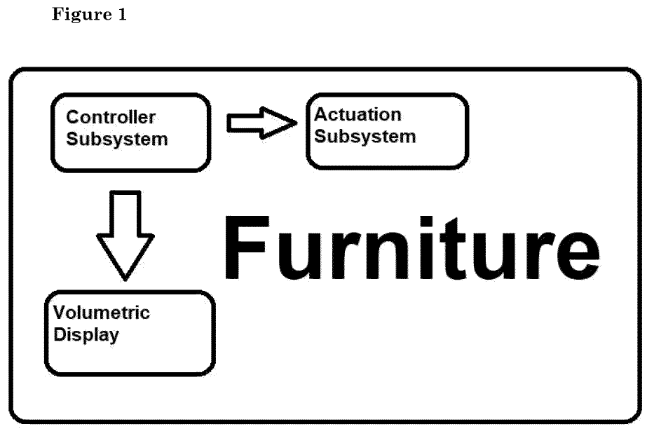

The invention will now be described by referencing the appended figures representing the general system architecture and flow. FIG. 1 depicts a block diagram showing the general functionality of the invention. When signaled by a sensor, switch, or other signaling instrument, the device begins to transform from Furniture mode to VLDS mode via the Actuation Subsystem or vice versa, depending upon the initial mode of the device. Three embodiments of this transformation process are described in ¶¶0043 through 0045, infra. These embodiments are meant to be illustrative examples and are in no way intended to limit the scope of the range of devices contemplated by this Application. A simpler Actuation Subsystem embodiment contemplated by this Application involves the user manually moving a part of the device or the entire device to transform it from Furniture mode to VLDS mode, e.g., as described in ¶0046, infra.

The present disclosure is to be considered as an exemplification of the invention and is not intended to limit the invention to the specific embodiments illustrated by the figures or descriptions herein. These potential configurations detail the functioning of systems in which the Screens are raised vertically, however, this Application also specifically contemplates embodiments in which the Screens are lowered vertically, moved horizontally, or moved at any degree between vertical and horizontal, or in any other direction to any degree, to transform the device from Furniture mode to VLDS mode. This Application also contemplates embodiments in which the Screens are generated by a gaseous cloud or by any other means. This Application also contemplates embodiments in which the Screens do not move relative to the remainder of the device, but in which another part of the device or the entire device itself is moved to transform the device from Furniture mode to VLDS mode.

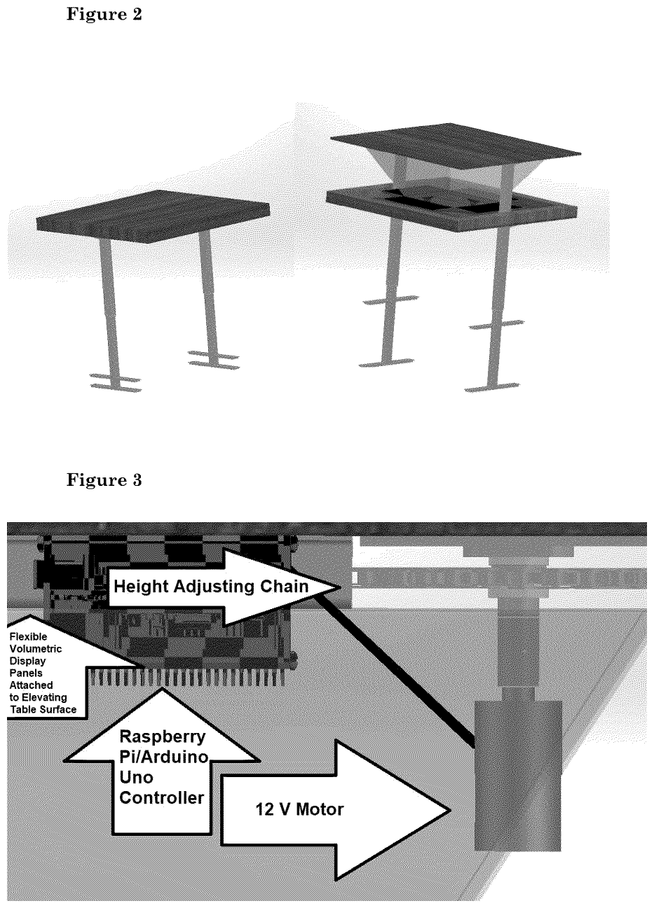

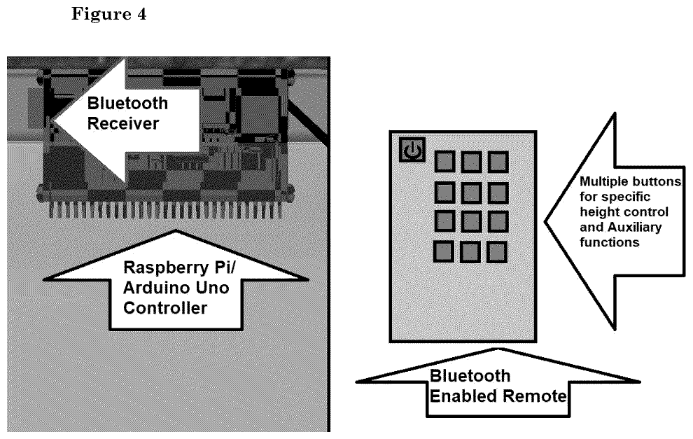

A potential configuration of the device will now be described by referring to the appended figures representing said configuration of the device. FIG. 2 depicts this configuration of the device as a whole. In its Furniture mode, the device functions as at table. When signaled to engage via a button, the Actuation Subsystem transforms the table into a VLDS by raising the tabletop and Screens non-proportionally using linear actuators. This process can be seen in FIG. 3. When in its VLDS mode, light from several monitors is refracted through panels of Plexiglas or a similar material to create a volumetric light display in the center of the device, creating the appearance of a three-dimensional image while reducing or eliminating the appearance of the media onto which that image is displayed.

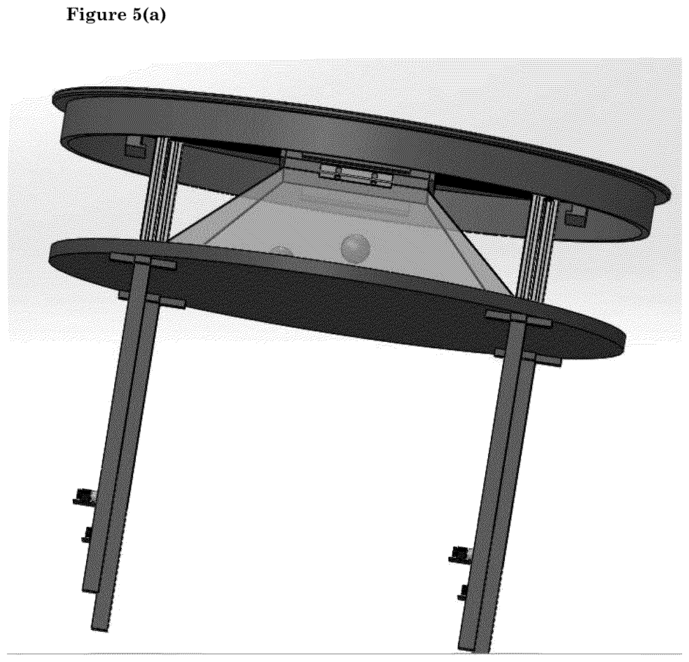

Referring now to FIG. 4, the Actuation Subsystem may be seen in further detail. In this configuration, this subsystem uses actuators or electric motors, such as but not limited to linear actuators or small electric winches attached to thin chains or cables to raise and lower pieces of the other two subsystems, for example: stepper motors (e.g., Motor Stepperonline Stepper Motor Nema 17 model number 17HS16-2004S manufactured by Stepperonline of Rowland Heights, CA; or High Torque Nema 23 CNC Stepper Motor model number FBA_23HS45-4204S manufactured by Stepperonline of Rowland Heights, CA); brushed direct current motors (e.g., Osepp Electronics model number LS-00025 manufactured by Osepp technologies of Tempe, AZ; or model number FIT0492-A brushed DC motor manufactured by DFRobot of Pudong, Shanghai, China); brushless direct current motors (e.g., model number B08P6MH99M 3600 kV brushless motor manufactured by Surpass Hobby of Winter Springs, FL; or model number B076B1GGWJ CF2812 1534Kv manufactured by RC Electric Parts of Orem, UT); servo motors (e.g., model number B097DWW6PY 35 kg servo motor manufactured by Feetech of Shenzhen, Guangdong, China; or model number B076CNKQX4 DS3218MG digital servo manufactured by Choclatras Annimos of Sao Paulo, Sao Palo, Brazil); alternating current motors (e.g., General Purpose Motor model number 6K477 manufactured by Dayton of Lake Forest, IL; or 3 HP Electric Motor 1 Phase; Mophorn model number ASIN B081J29Y6L manufactured by Shanghai Sishun E-Commerce Co., Ltd. of Shanghai, Shanghai, China); solenoids (e.g., MaySpare 250 Amp Winch Solenoid Relay, model number ASIN B07R6BP829 manufactured by Xu Xiaomin of Ruian City, Zhejiang, China; or Engine VVT Variable Valve model number SAB2-6414676 manufactured by Sawyer Auto of West Acton, MA); electroactive polymers (e.g., ionic electroactive polymers or electronic electroactive polymers); hydraulic pistons (e.g., SO15552 40 mm Bore 100 mm Stroke ¼″ NPT Air Cylinder model number SI40×100 manufactured by Toolots of Cerritos, CA; or Double Acting Hydraulic Cylinder, UNSPSC Code 27121602 manufactured by Magister Hydraulics of Bellville, NJ); servomechanisms (e.g., model number B097DWW6PY 35 kg servo motor manufactured by Feetech of Shenzhen, Guangdong, China; or model number B076CNKQX4 DS3218MG digital servo manufactured by Choclatras Annimos of Sao Paulo, Sao Palo, Brazil); and/or Piezoelectric actuators (e.g., Amplified Piezo Actuator model number APFH720 manufactured by Thor Labs of Newton, NJ). These motors or actuators are engaged via a controller such as but not limited to a Bluetooth enable remote control receiver (e.g., Logitech model number C-U0007 Unifying Receiver for Mouse and Keyboard manufactured by Logitech International S.A. of Newark, CA; or BT500—Network adapter—USB—Bluetooth 2.0 EDR model number Q6273A #1H9 manufactured by Hewlett-Packard of Palo Alto, CA), which signals a microcomputer (e.g., Raspberry Pi Foundation Raspberry Pi 3 Model B single-board computer attached to a Smart Projects Arduino Uno Rev 3 microprocessor). Also contemplated by this application are embodiments incorporating a semiconductor control interface system (e.g., H-Bridge Circuit L298N Motor Drive Controller Board Module model number MK-050-2 manufactured by H-Bridge of Qungi, Futian District, Shenzhen, China); Raspberry Pi Compatible Motor Control Boards (e.g., MotoZero manufactured by The Pi Hut of London, UK); low current motor drivers (e.g., model number A3918 Low Voltage DC Motor Driver manufactured by Allegro Microsystems of Manchester, NH; or model number DRV8824 Stepper Motor Driver Carrier manufactured by Texas Instruments of Dallas, TX); and/or TTL inputs (e.g., Arduino Diecimila manufactured by Arduino of Boston, Massachusetts; or TTL input module model number DSCA45 manufactured by Dataforth of Tucson, AZ), to process and relay signals from a signaling device to the actuation system. The remote-control receiver is in turn signaled by a button on a standalone remote-control transmitter (e.g., Xbox Wireless Controller manufactured by Microsoft Corporation of Redmond, WA; or Wii Remote manufactured by Nintendo of America of Redmond, WA). Alternatively, and further contemplated by this invention, the remote-control devices may be eliminated, and the microcomputer of the Actuation Subsystem may be signaled by a button, switch, or the equivalent mounted directly to the device or incorporated into the device itself. The height adjusting chains attached to the panels and actuators depicted cause the Screens to move when the table is raised by the actuators. These Screens comprise a key portion of the tabletop when the device is in Furniture mode and are a key element of the VLDS when the device is in VLDS mode.

Although the present invention has been illustrated and described herein with reference to potential embodiments and specific examples thereof, it will be readily apparent to those of ordinary skill in the art that other embodiments and potential embodiments may perform similar functions and/or achieve like results. A ready example would be to incorporate the novel Actuation Subsystem and VLDS subsystem into a piece of Furniture that is an affixed countertop, rather than a movable table. This potential embodiment is for illustrative purposes only and should not be read to limit in any way the variety of types of Furniture or types of VLDS subsystems which may be incorporated with an Actuation Subsystem to create an equivalent embodiment or similar device. All such equivalent embodiments and similar devices, affixed or movable, such as: desks; conference tables; dining tables; coffee tables; end tables; cabinets; armoires; shelves; shelving units; bookcases; counters; countertops; stands; pedestals; pulpits; podiums; pews; cases; stools; ottomans; carts; chairs; sofas; recliners; couches; thrones; benches; toilets; sinks; basins; tubs; showers; light fixtures; ceiling fans; ceiling fixtures; wall fixtures; floor fixtures; mirrors; paintings or other wall-mounted, floor-mounted, or ceiling-mounted art or decorative works; and any other manner of furniture or fixture, regardless of mobility, are within the spirit and scope of the present invention, are specifically contemplated thereby, and are intended to be covered by this Application.

This application is intended to cover any device comprising a Furniture subsystem, a VLDS subsystem, and an Actuation Subsystem. Such a device has two modes of function: Furniture mode or VLDS mode. The device may be switched between these modes through the innovative and novel application of an Actuation Subsystem.

The present invention comprises a novel device with the combined functionality of a piece of Furniture and a VLDS, depending on its mode. The third key component of the invention is the novel and innovative Actuation Subsystem, allowing the invention to change its functionality between that of a piece of Furniture and that of a VLDS. Such an Actuation Subsystem is comprised of any number of controllers and powered actuators or actuatorial systems to enable the device to transform between a Furniture mode and VLDS mode. Such an Actuation Subsystem may also be achieved by manually moving a portion of the device or the entire device in a specific manner, e.g., flipping it upside-down.

One embodiment of the device contemplated by this application is a piece of Furniture commonly referred to as a conference table. The user lifts a section of the tabletop by hand and either secures it in place by manual supports or removes it completely and sets it aside. The user then raises by hand four Plexiglas Screens and secures them in position at a predetermined angle to optimize the viewing experience. The user then strings several precisely-measured precut sections of monofilament line between the Screens to hold them in place. The device is now in VLDS mode. The user then energizes four carefully placed and oriented onboard projection devices, housed within the body of the table. Each projection device projects an image onto one of the Screens described supra. The user then connects a data transfer cable, such as an HDMI cable, a component video cable, a coaxial cable, and/or a VGA cable, from an external computer to an onboard image processor within the device. The onboard image processor then splits the image and manipulates it appropriately to provide the volumetric light display (an alternative embodiment contemplates the image processing function being performed in the external computer, with the onboard image processor appropriately routing portions of the processed signal to each of the four projection devices). The onboard image processor then sends synchronized images to each of the four onboard image projection devices. The four onboard image projection devices then project onto the four Screens, creating the appearance of a three-dimensional image while reducing or eliminating the appearance of the media onto which that image is displayed.

An alternative embodiment of the device contemplated by this application is a piece of Furniture commonly referred to as an affixed cabinet with a countertop. The user presses a button on a remote-control transmitter. The remote-control transmitter signals a remote-control receiver located within the cabinet or on a wall nearby. Upon receipt of the signal, the remote-control receiver sends a second signal, via wire or wirelessly, to a first onboard microprocessor. The first onboard microprocessor sends a third signal to an onboard projection relay. Upon receipt of this third signal, the onboard projection relay energizes four onboard Projectors, hidden from view beneath the countertop. The first onboard microprocessor also sends a fourth signal, this one to a second onboard microprocessor. Upon receipt of the fourth signal, the second onboard microprocessor sends a fifth signal to an onboard actuation relay. Upon receipt of this fifth signal, the onboard actuation relay energizes four actuators, hidden from view beneath the countertop. Once energized, each actuator raises a single Lexan panel Screen into position. Before the system was energized, the device was in its Furniture mode, and the Screens were hidden from view by a square section of the countertop. Each Screen is attached to one edge of the square section of the countertop via a track on the underside of the countertop section, and attached to the cabinet base by a hinge. Each track runs perpendicular from the midpoint of one edge of the countertop section, toward the center of the countertop section. Housed within each track is a wheel, the axle of which is attached by a bracket to the outer edge of a single Screen. As the four Screens are raised together, their outer edges pivot simultaneously upward and toward the center of the square countertop section. This pivoting toward the center of the square countertop section causes their attached wheels to roll within the tracks; the square countertop section thereby lifts the Screens and causes them to rotate into position. Once the maximum length of actuation travel has been reached, the device is in VLDS mode. Each actuator has a specific length of actuation travel, and this length of actuation travel determines to what height each Screen will be raised. The precise angle to which each Screen must be oriented for optimal viewing experience has been pre-determined, and actuators with an appropriate length of actuation travel have been selected and precisely installed in such a way as to raise the Screens to the appropriate pre-determined angle. Upon reaching their maximum length of actuation travel, the actuators stop and hold the Screens in position to maintain their pre-determined optimal viewing angles. The first onboard microprocessor sends a sixth signal to an onboard image processor relay. Upon receipt of the sixth signal the onboard image processor relay energizes the onboard image processor. Once energized, the onboard image processor warms up and awaits input from an external image generation device. The user connects an external image generation device, such as a laptop computer, a Roku device, or a cellular telephone to the onboard image processor, wirelessly or via wire. The external image generation device then sends data to the onboard image processor. The onboard image processor manipulates the data to appropriately provide the volumetric light display. The onboard image processor then sends synchronized volumetric light display images to each of the four onboard Projectors. The four onboard Projectors then project onto the four Screens, creating the impression of a three-dimensional image suspended in space. Ambient light is shaded by the square section of countertop that is lifted above the Screens, reducing or eliminating the appearance of the Screens.

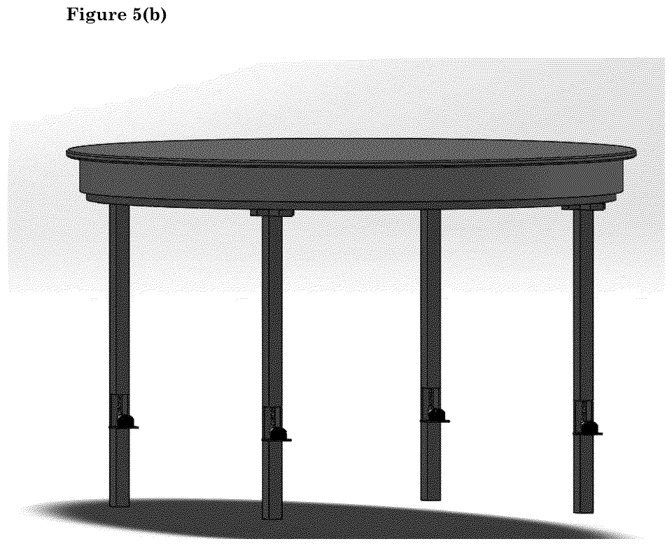

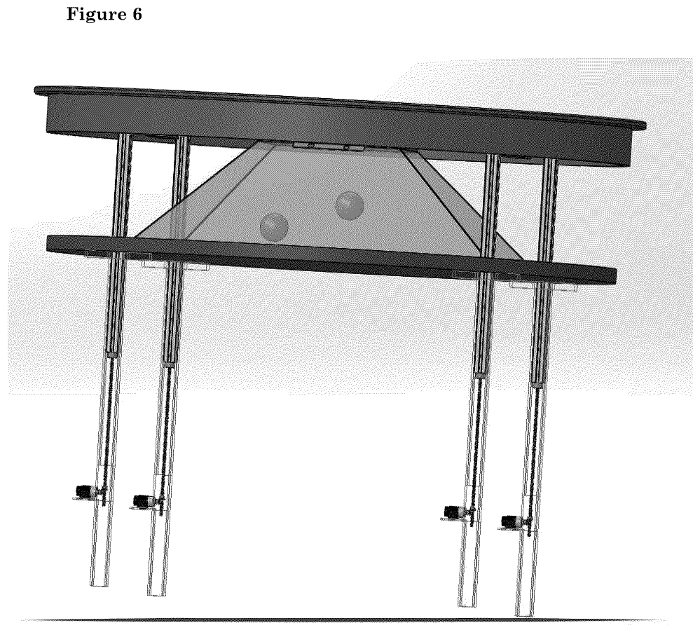

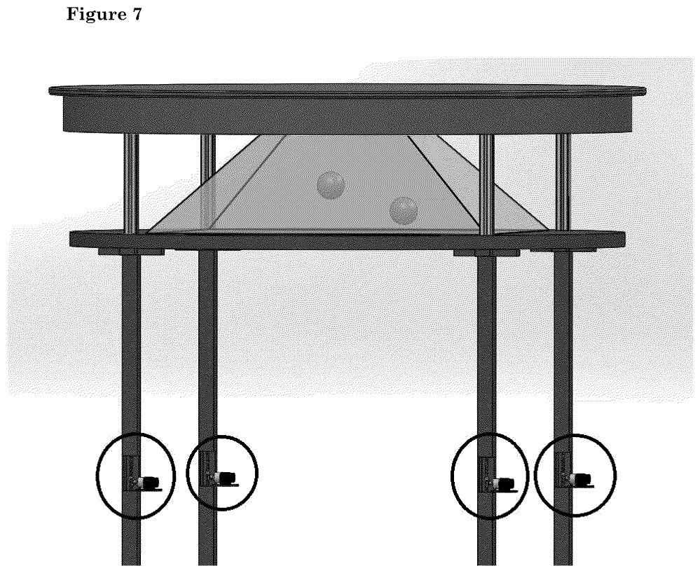

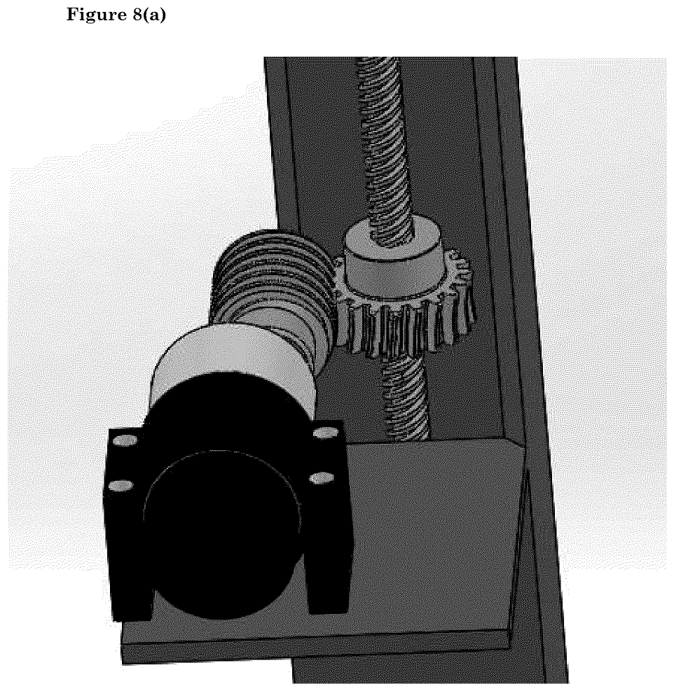

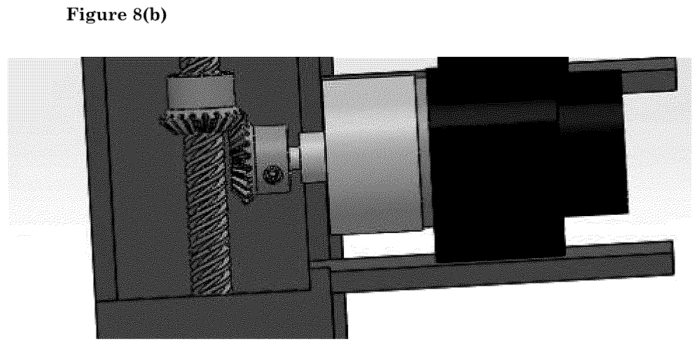

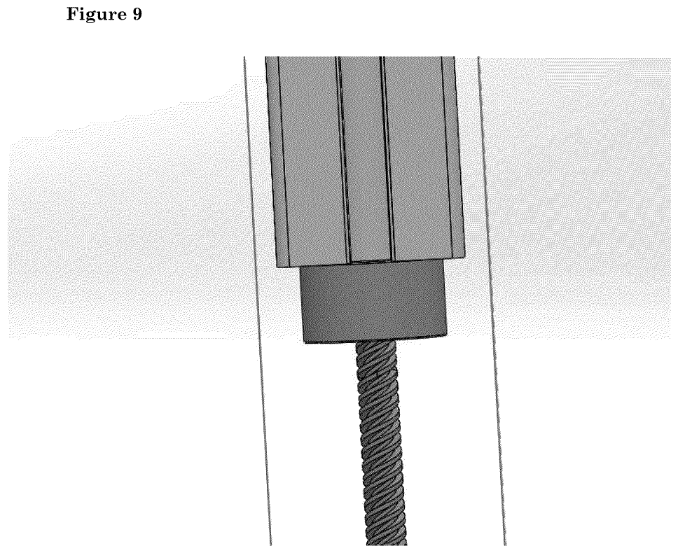

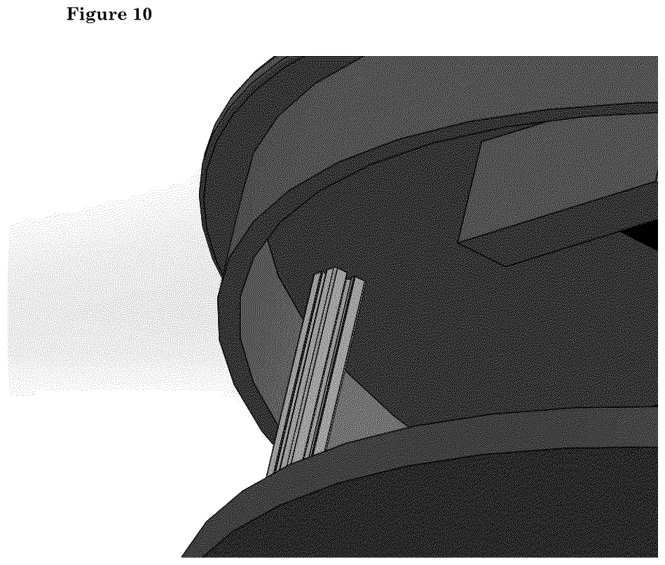

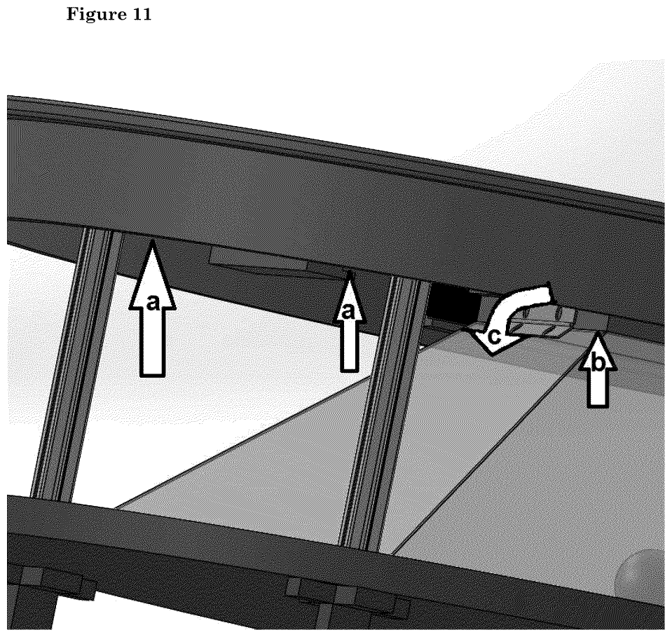

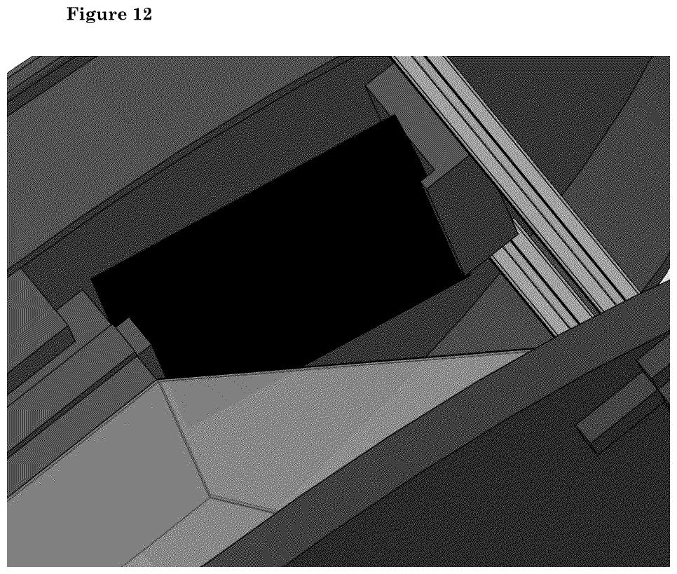

Yet another alternative embodiment of the device will now be described by referring to the appended figures representing said potential configuration of the device. FIGS. 5(a) and 5(b) illustrate a version of the device as a table in which screw jacks placed inside each of the four hollow table legs raise and lower the tabletop. The placement of the screw jacks is illustrated with more detail in FIG. 6. When the actuation subsystem of this configuration of the device receives the signal to transform, it sends power to four electric motors, one mounted to each table leg, as depicted in FIG. 7. Each electric motor (e.g., Pololu 150:1 Metal Gearmotor model number 4697 manufactured by Pololu Robotics and Electronics of Las Vegas, NV; Pololu 30:1 Metal Gearmotor model number 4692 manufactured by Pololu Robotics and Electronics of Las Vegas, NV; or Pololu 1:1 Metal Gearmotor model number 4690 manufactured by Pololu Robotics and Electronics of Las Vegas, NV) turns a bevel gear (e.g., McMaster-Carr Metal Miter Gear model number 6529K51 manufactured by McMaster-Carr Supply Company of Elmhurst, IL) or a worm gear (e.g., McMaster-Carr Steel Worm model number 57545K631 manufactured by McMaster-Carr Supply Company of Elmhurst, IL and McMaster-Carr Metal Worm Gear model number 57545K757 manufactured by McMaster-Carr Supply Company of Elmhurst, IL), which then turns the screw jack on that leg, as depicted in FIGS. 8(a) and 8(b). The threaded rod portion of each screw jack (e.g., McMaster-Carr 1018 Carbon Steel Precision Acme Lead Screw model number 99030A303 manufactured by McMaster-Carr Supply Company of Elmhurst, IL) spins and thereby raises a special nut (e.g., McMaster-Carr Cast Iron Precision Acme Round Nut model number 95365A501 manufactured by McMaster-Carr Supply Company of Elmhurst, IL) fitted onto the top of each such threaded rod. Each special nut is attached via a special washer (e.g., McMaster-Carr Steel Oversized Washer model number 96505A116 manufactured by McMaster-Carr Supply Company of Elmhurst, IL) to a hidden cylinder (e.g., McMaster-Carr T-Slotted Framing Rail model number 5537T103 manufactured by McMaster-Carr Supply Company of Elmhurst, IL) within each hollow table leg, as depicted in FIG. 9. When the special nuts rise, they push the four hidden cylinders up. The other end of each hidden cylinder is attached to the underside of the tabletop, as depicted in FIG. 10. As the four hidden cylinders rise in unison, they push the table top up, as demonstrated by arrows “a” in FIG. 11. As the table top rises, it pulls up with it four Screens, each attached to the underside of the table top with a piano hinge (e.g., Everbilt 1 1/16″×12″ Continuous Hinge model number 14649 manufactured by Home Depot Product Authority, L.L.C. of Atlanta, GA; or TooCust 1½″×24″ Piano Hinge model number TC21-PINO3 manufactured by Shanghai Kairong Tech of Shanghai, Shanghai, China) or any other type of hinge (e.g., Amazon Basics ⅜″ Self-Closing Kitchen Inset Cabinet Door Hinge model number AB-4000 manufactured by Amazon.com of Seattle, WA; or Everbilt 1″ Zinc Plated Non-Removable Pin Narrow Utility Hinges model number 15161 manufactured by Home Depot Product Authority, L.L.C. of Atlanta, GA), as demonstrated by arrow “b” in FIG. 11. As the Screens are pulled up, each hinge opens, allowing the angle from the Screen to the tabletop to increase proportionally, as demonstrated by arrow “c” in FIG. 11. Once the screw jacks travel a certain predetermined distance to allow the Screens to reach the optimum viewing angle, the actuation subsystem discontinues the power to the four electric motors, and the device rests statically in VLDS mode. Attached to the bottom of the tabletop, one to each side, are four Projectors, angled precisely relative to the Screens to create the optimum viewing experience, as depicted in FIG. 12. Unless the device is viewed from directly underneath, these Projectors are hidden from view by a deep “skirt” (such as a “skirt” made of wooden molding, e.g., Alexandria Moulding, 11/16″×3″×96″ Primed Casing Moulding model number 90411-96192C manufactured by Moulure Alexandria Moulding of Alexandria, Ontario, Canada) attached to the perimeter of the tabletop as depicted in FIG. 13. Hidden relays, microprocessors, and image processors, be they onboard or remote, manipulate and project the images onto the Screens, as described in ¶¶0033 and 0043, supra, or elsewhere in this Application, to produce the desired impression of a three-dimensional image suspended in space. Ambient light is shaded by the table top that pulled up the Screens, reducing or eliminating the appearance of the Screens.

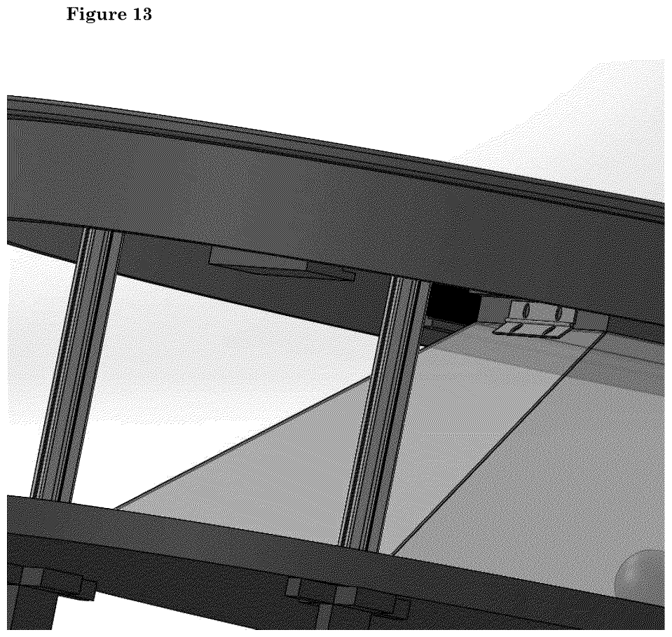

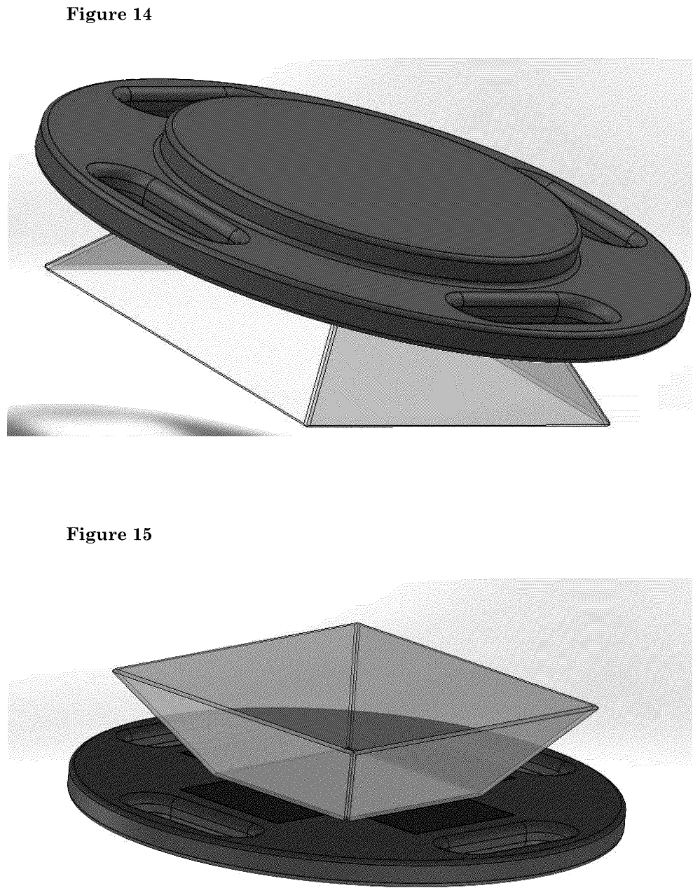

Another alternative, and much simpler, configuration of this device takes the form of a coffee table, consisting of a tabletop mounted to four trapezoidal Plexiglass or Lexan Screens arranged to form a truncated square-base pyramid that supports the tabletop. When the device is in Furniture mode, the long edges of the trapezoids rest on the floor, supporting the tabletop, as depicted in FIG. 14. Four Projectors are mounted to the underside of the tabletop. The device transforms to VLDS mode by the user manually flipping it upside-down. In VLDS mode, the tabletop rests on the floor and the pyramid of Screens is inverted, with the long edges of the trapezoids being the uppermost, as depicted in FIG. 15. The Projectors are now facing up. Hidden relays, microprocessors, and image processors, either onboard or remote, manipulate and project the images onto the Screens, as described in ¶¶0033 and 0043, supra, or elsewhere in this Application, to produce the desired impression of a three-dimensional image suspended in space.

This application specifically contemplates any combination or systems, components, and subsystems, such as those described supra, to create more-complex or less-complex versions of such a hybrid device that transforms between a Furniture mode and a VLDS mode. The four embodiments detailed supra are for illustrative purposes only and are in no means intended to be an exclusive list of embodiments of the device considered by this application. It will be readily apparent to those of ordinary skill in the art that other embodiments and potential embodiments may perform similar functions and/or achieve like results

1: What is claimed is a device consisting of a furniture subsystem, a volumetric light display subsystem, and an actuation subsystem.

1. Dependent claim number 1: Such a device has two modes of function: (1) furniture mode, and (2) volumetric light display mode.

1. Dependent claim number 2: The actuation subsystem transforms the device between these two modes and involves physically moving the device or a portion of the device through space.

1. Dependent claim number 3: The ability of the device to transform from furniture mode to volumetric light display mode is novel to this device.

1. Dependent claim number 4: Transforming the device between furniture mode and volumetric light display mode is non-obvious.
